(19) United States
(12) Patent Application Publication
(10) Pub. No.: US 2025/0140851 A1
(43) Pub. Date: May 1, 2025

(54) POSITIVE ELECTRODE ACTIVE MATERIAL AND LITHIUM ION SECONDARY BATTERY

(71) Applicant: HONDA MOTOR CO., LTD., Tokyo (JP)

(72) Inventors: Takashi HAKARI, Saitama (JP); Kazumasa SAKATSUME, Saitama (JP); Kazuki CHIBA, Saitama (JP); Akihisa TANAKA, Saitama (JP); Yoshiyuki MORITA, Saitama (JP)

(21) Appl. No.: 18/919,497

(22) Filed: Oct. 18, 2024

(30) Foreign Application Priority Data
Oct. 27, 2023 (JP) 2023-184422

(51) Int. Cl. H01M 4/58; H01M 4/02; H01M 4/38; H01M 4/583; H01M 10/0525

(52) U.S. Cl. CPC H01M 4/582; H01M 4/382; H01M 4/583; H01M 10/0525; H01M 2004/027; H01M 2004/028

(57) ABSTRACT

A positive electrode active material includes a lithium-iron composite fluoride as a principal component,
the lithium-iron composite fluoride being represented by Formula (1) below,

LiₓFeF₍₃₊ₓ₎ (1)
where, x is a number satisfying 0.5<x<1.5.

### BACKGROUND

### Technical Field

The present invention relates to a positive electrode active material and a lithium ion secondary battery.

### Related Art

In these years, research and development on secondary batteries that contribute to energy efficiency are conducted so that more people are able to access energy that is affordable, reliable, sustainable, and advanced. In particular, lithium ion secondary batteries are becoming increasingly important as power sources for electric vehicles (EVs), hybrid electric vehicles (HEVs), and the like.

A positive electrode active material has attracted attention as an important component for determining the capacity of a lithium ion secondary battery, and development thereof has been advanced. As a positive electrode active material used for a lithium ion secondary battery, for example, lithium iron phosphate (LiFePO₄) with low resource risk based on iron (Fe) has been known. LiFePO₄ is excellent in cycle characteristics and safety, but has a low voltage and a small capacity. Therefore, an energy density (voltage×capacity) represented by a product of the voltage and the capacity is small as compared to conventionally used materials based on nickel (Ni) or cobalt (Co). In order to manufacture a small battery, an electrode material with a high energy density is required, and in order to realize the high energy density, a high-voltage operation of a battery is important.

For the purpose of increasing the voltage of a battery using a material containing an element with low resource risk, the use of high-valent transition metals (for example, not Fe²⁺⇔Fe³⁺, but Fe³⁺⇔Fe⁴⁺) is expected. However, Fe⁴⁺ is very unstable and becomes Fe³⁺ by side reaction, or Fe⁴⁺ requires a large amount of energy and may not be produced. Thus, even though a Fe³⁺ compound is used as the positive electrode active material, it is not necessarily capable of operating at a high voltage.

For example, it has been reported in F. Badway, et al., “Carbon Metal Fluoride Nanocomposites” J. Electrochem. Soc., 150 (10) A1318-A1327 (2003) that LiFeF₃ is produced during charge and discharge by using ferric fluoride (FeF₃), and the average discharge voltage is 3.1 V. It has been reported in Y. Hu, et al., “A Simple, Quick and Eco-friendly Strategy of Synthesis Nanosized α-LiFeO₂ Cathode with Excellent Electrochemical Performance for Lithium-Ion Batteries” Materials, 11, 1176 (2018) that LiFeO₂ can be expected to have a high energy density.

### CITATION LIST

### Non Patent Literatures

Non Patent Literature 1: F. Badway, et al., “Carbon Metal Fluoride Nanocomposites” J. Electrochem. Soc., 150 (10) A1318-A1327 (2003) Non Patent Literature 2: Y. Hu, et al., “A Simple, Quick and Eco-friendly Strategy of Synthesis Nanosized α-LiFeO₂ Cathode with Excellent Electrochemical Performance for Lithium-Ion Batteries” Materials, 11, 1176 (2018)

### SUMMARY

In Y. Hu, et al., “A Simple, Quick and Eco-friendly Strategy of Synthesis Nanosized α-LiFeO₂ Cathode with Excellent Electrochemical Performance for Lithium-Ion Batteries” Materials, 11, 1176 (2018), the actual voltage is about 2.5 V, which is lower than the expected voltage. The average discharge voltage (3.1 V) described in F. Badway, et al., “Carbon Metal Fluoride Nanocomposites” J. Electrochem. Soc., 150 (10) A1318-A1327 (2003) is also lower than the voltage of LifePO₄, and there is room for improvement in order to further increase the voltage.

The present invention has been made to solve the above problems, and an object thereof is to provide a positive electrode active material that is based on Fe and capable of operating at a high voltage, and a lithium ion secondary battery containing the positive electrode active material. Furthermore, an additional object thereof is to reduce resource risks and contribute to cost reduction.

In order to achieve the above-described objects, the present invention provides the following aspects.

[1] A positive electrode active material including a lithium-iron composite fluoride as a principal component, the lithium-iron composite fluoride being represented by Formula (1) below,

LiₓFeF₍₃₊ₓ₎ (1)
where, x is a number satisfying 0.5<x<1.5.

The positive electrode active material according to [1] has a high average discharge voltage and can operate at a high voltage. Therefore, in a lithium ion secondary battery containing the positive electrode active material, the number of batteries required can be reduced, thereby contributing to cost reduction.

[2] The positive electrode active material according to [1], wherein in Formula (1), x satisfies 0.6≤x≤1.0.

The positive electrode active material according to [2] has a higher average discharge voltage and can operate at a higher voltage. Therefore, it is possible to contribute to more cost reduction.

[3] The positive electrode active material according to [1] or [2], wherein the positive electrode active material has a peak in a range of 20°≤2θ<25° and a range of 25°≤2θ≤30° in an X-ray diffraction pattern.

The positive electrode active material according to [3] has a peak derived from the crystal structure of FeF₃ and a peak derived from the crystal structure of LiFe₂F₆.

[4] A lithium ion secondary battery including a positive electrode, a negative electrode, and an electrolyte, wherein the positive electrode contains the positive electrode active material according to any one of [1] to [3].

In the lithium ion secondary battery according to [4], the positive electrode contains the positive electrode active material according to [1] to [3]. This indicates that the battery can operate at a high voltage.

[5] The lithium ion secondary battery according to [4], wherein a dQ/dV plot during discharge in a charge-discharge cycle has a peak in a range of 3.77 to 4.0 V.

This indicates that, in the lithium ion secondary battery according to [5], the positive electrode active material undergoes a chemical reaction in a high voltage range of 3.77 to 4.0 V. This indicates that the battery can operate at a higher voltage.

[6] The lithium ion secondary battery according to [4] or [5], wherein a peak height at 3.77 to 4.0 V is 1.2 times to 4.4 times a peak height at 3.3 to 3.5 V in a dQ/dV plot during discharge in a charge-discharge cycle.

This indicates that, in the lithium ion secondary battery according to [6], the positive electrode active material undergoes a chemical reaction in a high voltage range of 3.77 to 4.0 V. This indicates that the battery can operate at a higher voltage.

[7] The lithium ion secondary battery according to any one of [4] to [6], wherein an average discharge voltage is 3.8 to 4.0 V.

The lithium ion secondary battery according to [7] has a high average discharge voltage of 3.8 to 4.0 V. This indicates that the battery can operate at a high voltage.

[8] The lithium ion secondary battery according to any one of [4] to [7], wherein the electrolyte is a liquid electrolyte, a solid electrolyte, or a semi-solid electrolyte.

The lithium ion secondary battery according to [8] can utilize any of the liquid electrolyte, the solid electrolyte, or the semi-solid electrolyte. Therefore, the lithium ion secondary battery can be applicable to various types of batteries.

[9] The lithium ion secondary battery according to any one of [4] to [8], wherein the negative electrode is formed of metallic lithium or graphite.

The lithium ion secondary battery according to [9] can be applicable to a battery including a negative electrode formed of metallic lithium or graphite. Therefore, the lithium ion secondary battery can be applicable to various types of batteries.

According to the present invention, it is possible to provide the positive electrode active material that is based on Fe and capable of operating at a high voltage, and the lithium ion secondary battery containing the positive electrode active material.

### BRIEF DESCRIPTION OF DRAWINGS

FIG. 1 is a diagram illustrating an X-ray diffraction pattern of a positive electrode active material according to an embodiment of the present invention;

FIG. 2 is a cross-sectional view schematically illustrating a lithium ion secondary battery according to the embodiment of the present invention;

FIG. 3 is a graph illustrating a charge-discharge curve in a charge-discharge cycle of the lithium ion secondary battery according to the embodiment of the present invention;

FIG. 4 is a graph illustrating a dQ/dV plot in the charge-discharge cycle of FIG. 3;

FIG. 5 is a graph illustrating a dQ/dV plot in a charge-discharge cycle of a lithium ion secondary battery according to another embodiment of the present invention;

FIG. 6 is a diagram illustrating X-ray diffraction patterns of positive electrode active materials according to Examples 1 to 5 and Comparative Example 1;

FIG. 7 is a graph illustrating a charge-discharge curve of a lithium ion secondary battery containing a positive electrode active material of Example 1;

FIG. 8 is a graph illustrating a charge-discharge curve of a lithium ion secondary battery containing a positive electrode active material of Example 2;

FIG. 9 is a graph illustrating a charge-discharge curve of a lithium ion secondary battery containing a positive electrode active material of Example 3;

FIG. 10 is a graph illustrating a charge-discharge curve of a lithium ion secondary battery containing a positive electrode active material of Example 4;

FIG. 11 is a graph illustrating a charge-discharge curve of a lithium ion secondary battery containing a positive electrode active material of Example 5;

FIG. 12 is a graph illustrating a charge-discharge curve of a lithium ion secondary battery containing a positive electrode active material of Comparative Example 1;

FIG. 13 is a graph illustrating a dQ/dV plot in the charge-discharge cycle of FIG. 7;

FIG. 14 is a graph illustrating a dQ/dV plot in the charge-discharge cycle of FIG. 8;

FIG. 15 is a graph illustrating a dQ/dV plot in the charge-discharge cycle of FIG. 9;

FIG. 16 is a graph illustrating a dQ/dV plot in the charge-discharge cycle of FIG. 10;

FIG. 17 is a graph illustrating a dQ/dV plot in the charge-discharge cycle of FIG. 11; and

FIG. 18 is a graph illustrating a dQ/dV plot in the charge-discharge cycle of FIG. 12.

### DETAILED DESCRIPTION

Hereinafter, preferred embodiments of the present invention will be described in detail with reference to the accompanying drawings.

### [Positive Electrode Active Material]

A positive electrode active material of the present embodiment contains a lithium-iron composite fluoride as a principal component, and is used in a positive electrode of a lithium ion secondary battery. The phrase “contains a lithium-iron composite fluoride as a principal component” means that the content of the lithium-iron composite fluoride is 75% by mass or more, preferably 80% by mass or more, more preferably 90% by mass or more, and still more preferably 99% by mass or more with respect to the total mass of the positive electrode active material, and may be 100% by mass. The positive electrode active material may contain components other than the principal component as long as the function of the present invention is not impaired.

The positive electrode active material of the present embodiment may contain only one kind or two or more kinds of lithium-iron composite fluoride as long as the lithium-iron composite fluoride is contained as a principal component.

In a case where the positive electrode active material is produced by using the lithium-iron composite fluoride as a principal component, the total composition ratio (Li:Fe:F) of the lithium-iron composite fluoride is also maintained in the obtained positive electrode active material. In a case where the positive electrode active material obtained by using the lithium-iron composite fluoride having such a composition as a principal component is used in a secondary battery, a high-voltage operation can be achieved. In addition, the composition ratio of the lithium-iron composite fluoride is adjusted to be the same as a composition ratio required for a desired positive electrode active material.

### (Lithium-Iron Composite Fluoride)

The lithium-iron composite fluoride of the present embodiment is represented by Formula (1) below.

LiₓFeF₍₃₊ₓ₎ (1)
where, x is a number satisfying 0.5<x<1.5. In Formula (1), x is preferably 0.6≤x≤1.2, more preferably 0.6≤x≤1.0, and still more preferably 0.7≤x≤1.0. In a case where x is within the above-described numerical range, the average discharge voltage can be increased, and a higher-voltage operation can be achieved. Therefore, a small battery with a high energy density can be manufactured.

In Formula (1), x represents a molar ratio of Li to Fe. The molar ratio of Li to Fe is x:1. In addition, the molar ratio of Li, Fe, and F is x:1:(3+x).

The composition of the lithium-iron composite fluoride can be determined by inductively coupled plasma (ICP) optical emission spectrometry.

### <X-Ray Diffraction (XRD) Pattern>

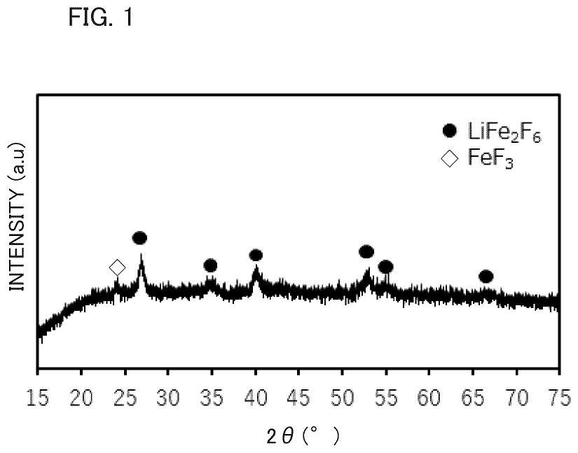

FIG. 1 illustrates, as an example of an X-ray diffraction (XRD) pattern of the positive electrode active material according to the present embodiment, an XRD pattern of Example 4 described later. As illustrated in FIG. 1, the positive electrode active material of the present embodiment preferably has peaks in a range of 20°≤ 2θ<25° and a range of 25°≤2θ≤30°, respectively. The peak in the range of 20°≤2θ<25° represents a peak derived from the crystal structure of FeF₃ which is trivalent iron. The peak in the range of 25°≤2θ≤30° represents a peak derived from the crystal structure of LiFe₂F₆. This means that the positive electrode active material of the present embodiment has the same crystal structure as those of FeF₃ and LiFe₂F₆. In the lithium-iron composite fluoride of the present embodiment, iron is entirely composed of Fe₃₊ in the composition ratio of LiFeF₄. Therefore, the following Formula (2) is obtained as described according to the composition formula of LiFe₂F₆ of a tetragonal crystal system with space group P42/mnm.

Li_{y}Fe₂F_{(6+y)} (2)

In Formula (2), y is a number satisfying 1<y<3.

### [Lithium Ion Secondary Battery]

The lithium ion secondary battery of the present embodiment includes a positive electrode, a negative electrode, and an electrolyte, and the positive electrode contains a positive electrode active material containing the above-described lithium-iron composite fluoride as a principal component. The lithium ion secondary battery of the present embodiment may include other battery elements as necessary.

In the lithium ion secondary battery of the present embodiment, a known battery element of the lithium ion secondary battery can be employed as it is except that the positive electrode contains a positive electrode active material containing the above-described lithium-iron composite fluoride as a principal component. The lithium ion secondary battery of the present embodiment may have any of a coin type, a button type, a cylindrical type, a square type, and a laminate type. In addition, the lithium ion secondary battery of the present embodiment is applicable to a wide range of applications such as mobile devices including mobile phones and laptop computers, and in-vehicle applications.

Hereinafter, with respect to the lithium ion secondary battery of the present embodiment, a lithium ion secondary battery (coin-type lithium ion secondary battery) using an electrolytic solution will be described. Each battery element described below can be similarly applied to an all-solid-state lithium ion secondary battery not using an electrolytic solution and a semi-solid lithium ion secondary battery.

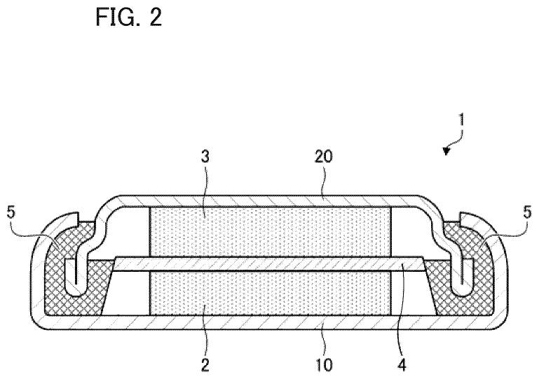

As illustrated in FIG. 2, a lithium ion secondary battery 1 of the present embodiment includes a negative electrode can (negative electrode terminal) 20, a negative electrode 3, a separator 4 impregnated with an electrolytic solution, an insulating packing (gasket) 5, a positive electrode 2, and a positive electrode can 10.

The positive electrode can 10 is disposed below the separator 4, the negative electrode can 20 is disposed over the separator 4, and the outer shape of the lithium ion secondary battery 1 is formed by the positive electrode can 10 and the negative electrode can 20. The positive electrode 2 and the negative electrode 3 are provided between the positive electrode can 10 and the negative electrode can 20 with the separator 4 impregnated with an electrolytic solution interposed therebetween, and the positive electrode 2 and the negative electrode 3 are separated from each other by the separator 4. The positive electrode can 10 and the negative electrode can 20 are electrically insulated from each other by the insulating packing 5.

In the lithium ion secondary battery 1, a positive electrode mixture is prepared by blending a conductive agent, a binder, and the like with the positive electrode active material of the present embodiment as necessary, and the positive electrode 2 can be produced by pressing the positive electrode mixture to a current collector (not illustrated).

As the current collector, a stainless steel mesh, an aluminum foil, or the like can be preferably used. As the conductive agent, a carbon nanotube (CNT), acetylene black, Ketjenblack, or the like can be preferably used. As the binder, tetrafluoroethylene, polyvinylidene fluoride, or the like can be preferably used.

Blending of the positive electrode active material, the conductive agent, and the binder in the positive electrode mixture is not particularly limited. The content of the positive electrode active material in the positive electrode mixture is preferably 75% to 100% by mass, and more preferably 90% to 99% by mass. The content of the conductive agent in the positive electrode mixture is preferably 1% to 15% by mass, and more preferably 0.1% to 5% by mass. The content of the binder in the positive electrode mixture is preferably 0.1% to 10% by mass, and more preferably 0.1% to 5% by mass.

In the lithium ion secondary battery 1, as the negative electrode 3 with respect to the positive electrode 2, a known electrode, for example, a metal-based material such as metallic lithium and a lithium alloy, a carbon-based material such as graphite and mesocarbon microbeads (MCMB), and a silicon-based material such as silicon (Si), a Si alloy, and silicon oxide, which functions as a negative electrode active material and is capable of intercalating and deintercalating lithium, can be employed. Among these, metallic lithium and graphite are preferable as the negative electrode 3.

Known battery elements can be employed as the separator 4 and a battery container (positive electrode can 10 and negative electrode can 20).

As the electrolyte, a known electrolytic solution, a known semi-solid electrolyte, a known solid electrolyte, or the like can be employed. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

As the semi-solid electrolyte and the solid electrolyte, a known semi-solid electrolyte and a known solid electrolyte can be used in addition to the positive electrode active material containing the above-described lithium-iron composite fluoride being used as a principal component.

Examples of the semi-solid electrolyte include an electrolyte composed of a polymer component and a standard electrolytic solution. Examples of the polymer component include polyvinylidene fluoride (PVDF)/polyethylene oxide (PEO), polyacrylonitrile (PAN)/PEO, polymethyl methacrylate (PMMA), PVDF/hexafluoropropylene (HFP), and other polymer components. Examples of the standard electrolytic solution include a solution of 1 mol/L lithium hexafluorophosphate (LiPF₆) in EC/DMC, a solution of 1 mol/L LiPF₆ in EC/ethyl methyl carbonate (EMC), a solution of 1 mol/L LiPF₆ in EC/DMC/EMC, and other standard electrolytic solutions.

As for the all-solid-state lithium ion secondary battery, as the electrolyte, for example, solid electrolytes such as a polymer-based solid electrolyte such as a polyethylene oxide-based polymer compound and a polymer compound containing at least one or more of a polyorganosiloxane chain and a polyoxyalkylene chain, a sulfide-based solid electrolyte, and an oxide-based solid electrolyte can be used.

For the positive electrode of the all-solid-state lithium ion secondary battery, for example, a positive electrode mixture containing a solid electrolyte in addition to the positive electrode active material, the conductive agent, and the binder can be carried on a positive electrode current collector such as aluminum, nickel, and stainless steel.

In the lithium ion secondary battery 1 of the present embodiment, since the positive electrode 2 contains the positive electrode active material of the present embodiment, a high-voltage operation can be achieved.

<dQ/dV Plot of Charge-Discharge Cycle>

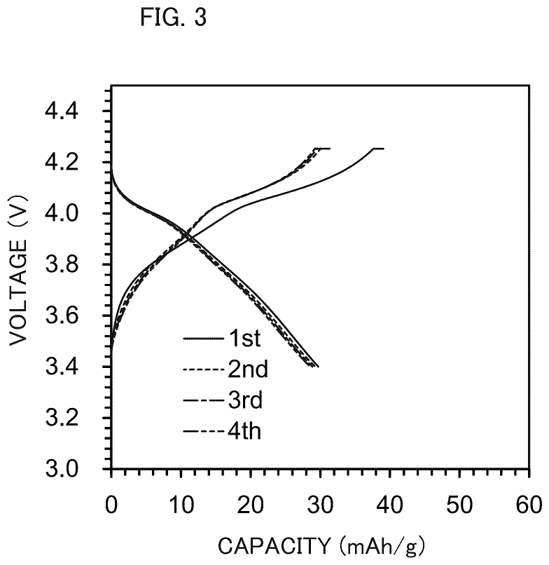

FIG. 3 illustrates a graph for Example 4 described later as an example of a charge-discharge curve in a charge-discharge cycle of the lithium ion secondary battery of the present embodiment. The horizontal axis of the graph of FIG. 3 represents the capacity of the lithium ion secondary battery. The vertical axis of the graph of FIG. 3 represents the voltage of the lithium ion secondary battery during charge and discharge. In the charge-discharge curve of FIG. 3, the right-upward curve represents a curve during charge, and the left-upward curve represents a curve during discharge. In FIGS. 3, 1st, 2nd, 3rd, and 4th represent the number of charge-discharge cycles.

The capacity of the lithium ion secondary battery illustrated in FIG. 3 is 30 mAh/g, and the voltage of the curve during discharge at 15 mAh/g, which is half the capacity, is the average discharge voltage. As illustrated in FIG. 3, the lithium ion secondary battery of the present embodiment has an average discharge voltage of about 3.8 V.

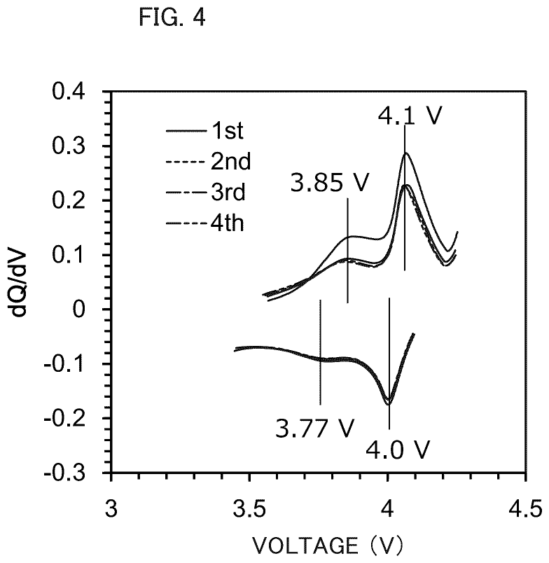

In FIG. 4, a dQ/dV plot in the charge-discharge cycle of FIG. 3 is illustrated. The horizontal axis of the graph in FIG. 4 represents the voltage in a charge-discharge cycle. The vertical axis of the graph in FIG. 4 represents a value (dQ/dV plot, dodV⁻¹ plot) obtained by differentiating the capacity of FIG. 3 with respect to the voltage. In FIG. 4, upwardly convex curves represent curves during charge, and downwardly convex curves represent curves during discharge. In FIGS. 4, 1st, 2nd, 3rd, and 4th represent the number of charge-discharge cycles.

As illustrated in FIG. 4, the curves during charging have peaks at 3.85 V and 4.1 V. The curves during discharge have peaks at 3.77 V and 4.0 V. These peaks indicate that the positive electrode active material undergoes a chemical reaction in the positive electrode during charge or discharge. This indicates that the chemical reaction occurs in a high voltage range of 3.77 to 4.0 V during discharge, and the lithium ion secondary battery can operate at a high voltage.

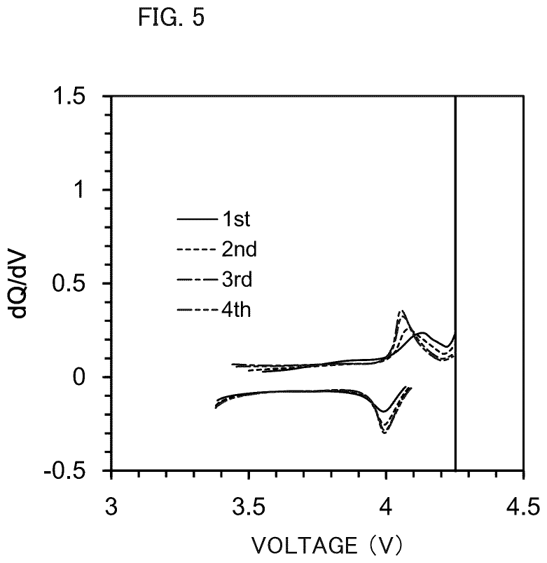

FIG. 5 illustrates a graph for Example 1 described later as an example of a dQ/dV plot in a charge-discharge cycle of the lithium ion secondary battery according to another embodiment. In FIG. 5, upwardly convex curves represent curves during charge, and downwardly convex curves represent curves during discharge. In FIGS. 5, 1st, 2nd, 3rd, and 4th represent the number of charge-discharge cycles.

The curve during discharge in Example 1 has a peak at each of 3.5 V, 3.77 V, and 4.0 V. The dQ/dV value of the peak at 3.5 V is −0.0708 mAhg⁻¹V⁻¹, the dQ/dV value of the peak at 3.77 V is −0.090 mAhg⁻¹V⁻¹, and the dQ/dV value of the peak at 4.0 V is −0.1634 mAhg⁻¹V⁻¹. The dQ/dV value of each peak represents the average value of three charge-discharge cycles excluding the first cycle. The peak height at 3.77 V is −0.090/−0.0708=1.27 times the peak height at 3.5 V, and the peak height at 4.0 V is −0.1634/−0.0708=2.31 times the peak height at 3.5 V. In the curve during discharge in Example 3 described later, the dQ/dV value of the peak at 3.5 V is −0.107 mAhg⁻¹V⁻¹, and the dQ/dV value of the peak at 4.0 V is −0.464 mAhg⁻¹V⁻¹. In Example 3, the peak height at 4.0 V is −0.464/−0.107=4.34 times the peak height at 3.5 V. As described above, in the curves during discharge in Examples 1 and 3, the peak height at 3.77 to 4.0 V is 1.2 times to 4.4 times the peak height at 3.3 to 3.5 V. This indicates that the chemical reaction is occurring at 3.77 to 4.0 V with a substance amount that is 1.2 to 4.4 times greater than the chemical reaction occurring at 3.3 to 3.5 V during discharge, and the lithium ion secondary battery can operate at a high voltage.

The average discharge voltage of the lithium ion secondary battery of the present embodiment is preferably 3.8 to 4.0 V, and more preferably 3.8 to 3.9 V. In a case where the average discharge voltage of the lithium ion secondary battery is equal to or greater than the above lower limit value, a higher-voltage operation can be achieved. The upper limit value of the average discharge voltage of the lithium ion secondary battery is not particularly limited, but is substantially 4.0 V.

### [Method for Producing Positive Electrode Active Material]

The positive electrode active material of the present embodiment contains the above-described lithium-iron composite fluoride as a principal component. As a lithium source of the lithium-iron composite fluoride, it is possible to use a known compound such as a halide such as lithium fluoride (LiF), a hydroxide such as lithium hydroxide monohydrate (LiOH·H₂O), a carbonate such as lithium carbonate (Li₂CO₃), or an acetate such as lithium acetate (CH₃COOLi) and lithium acetate dihydrate (CH₃COOLi·2H₂O), and there is no particular limitation.

As an iron source of the lithium-iron composite fluoride, trivalent iron is preferable rather than divalent iron, and ferric fluoride (FeF₃) is more preferable, because a high-voltage operation can be achieved.

In a case where the lithium-iron composite fluoride is produced, the above-described lithium source and iron source are mixed and subjected to mechanical processing (mechanical treatment) under predetermined conditions for a predetermined time. For example, in a case where lithium fluoride is used as the lithium source, and trivalent iron (FeF₃) is used as the iron source, it is considered that the compound represented by Formula (1) described above can be produced by the following reaction.

LiF+FeF₃→LiFeF₄ (the compound in Formula (1), where x=1)

The value of x in the compound represented by Formula (1) described above can be adjusted by a molar ratio of LiF and FeF₃.

The specific device applied in the mechanical treatment is not particularly limited, but various devices conventionally used for the purpose of pulverizing and mixing a solid substance can be applied. Among these devices, a ball mill is preferable, and a planetary ball mill is more preferable because raw materials can be sufficiently pulverized and mixed.

The time for performing the mechanical treatment is preferably, for example, 8 to 12 hours, and more preferably 9 to 11 hours.

As a condition for performing the mechanical treatment, the rotation speed is preferably 250 to 450 rpm, and more preferably 300 to 400 rpm.

The temperature at which the mechanical treatment is performed is not particularly limited, and the mechanical treatment can be performed at room temperature (for example, 5° C. to 30° C.).

The atmosphere during the mechanical treatment is preferably an inert gas (a rare gas such as argon (Ar), nitrogen (N₂) gas, and other gases)

After the compound represented by Formula (1) is obtained by the mechanical treatment, it is preferable to perform carbon coating by pulverizing and mixing the compound represented by Formula (1) together with carbon fine particles from the viewpoint of improving the capacity and rate characteristics. As the carbon fine particles, for example, a carbon nanotube (CNT), acetylene black, Ketjenblack, or the like can be used. Among these carbon fine particles, the CNT is preferable from the viewpoint of further improving the conductivity of the positive electrode active material.

As the pulverizing and mixing conditions at the time of carbon coating, the same time and conditions as those of the mechanical treatment described above can be applied. A battery that operates at a high voltage can be obtained by producing the lithium ion secondary battery with the obtained positive electrode active material as a positive electrode.

### EXAMPLES

Next, examples of the present invention will be described, but the present invention is not limited to the examples below.

### Example 1 (Preparation of Li_{0.6}FeF_{3.6} (Compound in Formula (1), Where x=0.6))

The mechanical treatment was performed with 0.439 g of ferric fluoride (FeF₃) and 0.0606 g of lithium fluoride (LiF) by using a planetary ball mill machine. As the planetary ball mill machine, Premium line PL-7 manufactured by Fritsch GmbH was used. A pot and balls were made of zirconium oxide, and 50 g of balls with a diameter of 5 mm was used in the 45 mL pot. The treatment conditions of the mechanical treatment were 350 rpm and 10 hours. Thereafter, 0.55 g of carbon nanotube (CNT) was added into the pot, and the mechanical treatment was further performed to obtain a positive electrode active material. The treatment conditions of the mechanical treatment in obtaining the positive electrode active material were 25° C., 350 rpm, and 10 hours under an Ar atmosphere.

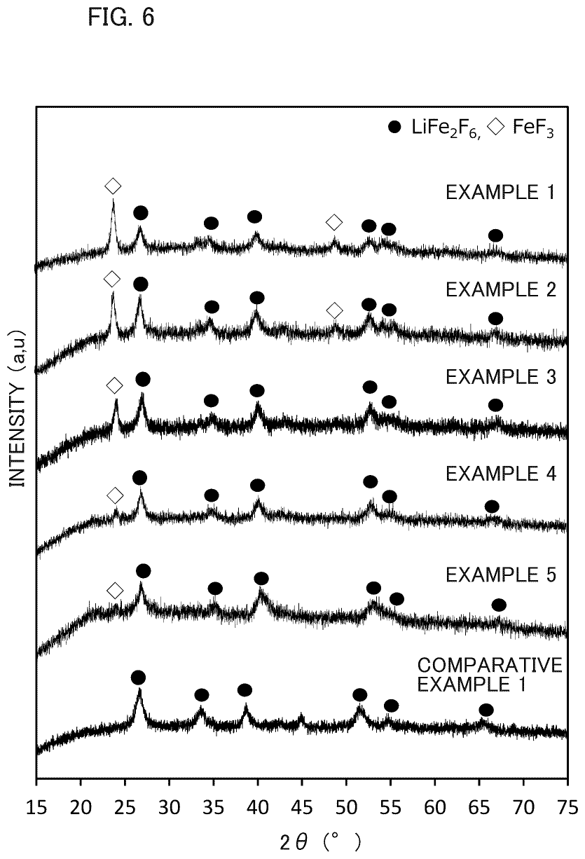

The obtained positive electrode active material was subjected to X-ray diffraction measurement according to the following measurement conditions. The results are illustrated in FIG. 6.

### <<X-Ray Diffraction Measurement Conditions>>

X-ray diffractometer: SmartLab manufactured by Rigaku Corporation
X-ray source: CuKα radiation (CuKα=1.5418 Å)
Opening angle of incident parallel slit: 5.0°
Incident length-limiting slit: 5.0 mm
Opening angle of receiving parallel slit: 5.0°
Kβ filter: Used
Step width: 0.01° Incident slit: ⅙°
Receiving slit 1:4.0 mm
Receiving slit 2:13 mm

As illustrated in FIG. 6, it was found that the obtained positive electrode active material has a crystal structure similar to those of FeF₃ and LiFe₂F₆, in agreement with the diffraction patterns of FeF₃ of a trigonal crystal system in a R-3c space group with DB card number 00-061-0194 and LiFe₂F₆ of a tetragonal crystal system in a P42/mnm space group with DB card number 01-074-2193.

### Example 2

(Preparation of Li_{0.7}FeF_{3.7} (Compound in Formula (1), Where x=0.7))

A positive electrode active material was obtained in the same manner as in Example 1, except that the mechanical treatment was performed with 0.431 g of ferric fluoride (FeF₃) and 0.0693 g of lithium fluoride (LiF) by using a planetary ball mill machine.

The obtained positive electrode active material was subjected to X-ray diffraction measurement under the same conditions as those in Example 1. The results are illustrated in FIG. 6.

As illustrated in FIG. 6, it was found that the obtained positive electrode active material has a crystal structure similar to those of FeF₃ and LiFe₂F₆, in agreement with the diffraction patterns of FeF₃ of a trigonal crystal system in a R-3c space group with DB card number 00-061-0194 and LiFe₂F₆ of a tetragonal crystal system in a P42/mnm space group with DB card number 01-074-2193.

### Example 3

(Preparation of Li_{0.8}FeF_{3.8} (Compound in Formula (1), Where x=0.8))

A positive electrode active material was obtained in the same manner as in Example 1, except that the mechanical treatment was performed with 0.422 g of ferric fluoride (FeF₃) and 0.078 g of lithium fluoride (LiF) by using a planetary ball mill machine.

The obtained positive electrode active material was subjected to X-ray diffraction measurement under the same conditions as those in Example 1. The results are illustrated in FIG. 6.

As illustrated in FIG. 6, it was found that the obtained positive electrode active material has a crystal structure similar to those of FeF₃ and LiFe₂F₆, in agreement with the diffraction patterns of FeF₃ of a trigonal crystal system in a R-3c space group with DB card number 00-061-0194 and LiFe₂F₆ of a tetragonal crystal system in a P42/mnm space group with DB card number 01-074-2193.

### Example 4

(Preparation of LiFeF₄ (Compound in Formula (1), Where x=1.0))

A positive electrode active material was obtained in the same manner as in Example 1, except that the mechanical treatment was performed with 0.407 g of ferric fluoride (FeF₃) and 0.0934 g of lithium fluoride (LiF) by using a planetary ball mill machine.

The obtained positive electrode active material was subjected to X-ray diffraction measurement under the same conditions as those in Example 1. The results are illustrated in FIG. 6.

As illustrated in FIG. 6, it was found that the obtained positive electrode active material has a crystal structure similar to those of FeF₃ and LiFe₂F₆, in agreement with the diffraction patterns of FeF₃ of a trigonal crystal system in a R-3c space group with DB card number 00-061-0194 and LiFe₂F₆ of a tetragonal crystal system in a P42/mnm space group with DB card number 01-074-2193.

### Example 5

(Preparation of Li_{1.2}FeF_{4.2} (Compound in Formula (1), Where x=1.2))

A positive electrode active material was obtained in the same manner as in Example 1, except that the mechanical treatment was performed with 0.391 g of ferric fluoride (FeF₃) and 0.108 g of lithium fluoride (LiF) by using a planetary ball mill machine.

The obtained positive electrode active material was subjected to X-ray diffraction measurement under the same conditions as those in Example 1. The results are illustrated in FIG. 6.

As illustrated in FIG. 6, it was found that the obtained positive electrode active material has a crystal structure similar to those of FeF₃ and LiFe₂F₆, in agreement with the diffraction patterns of FeF₃ of a trigonal crystal system in a R-3c space group with DB card number 00-061-0194 and LiFe₂F₆ of a tetragonal crystal system in a P42/mnm space group with DB card number 01-074-2193.

[Comparative Example 1](Preparation of LiFeF₃)

A positive electrode active material was obtained in the same manner as in Example 1, except that the mechanical treatment was performed with 0.392 g of ferrous fluoride (FeF₂) and 0.108 g of lithium fluoride (LiF) by using a planetary ball mill machine.

The obtained positive electrode active material was subjected to X-ray diffraction measurement under the same conditions as those in Example 1. The results are illustrated in FIG. 6.

As illustrated in FIG. 6, it was found that the obtained positive electrode active material has a crystal structure similar to that of LiFe₂F₆, in agreement with the diffraction pattern of Life₂F₆ of a tetragonal crystal system in a P42/mnm space group with DB card number 01-074-2193.

### [Production of Lithium Ion Secondary Battery]

### (Production of Positive Electrode)

A slurry (positive electrode mixture) containing, as solid contents, 80% by mass of the positive electrode active material, 10% by mass of acetylene black, and 10% by mass of polyvinylidene fluoride was prepared by dispersing 80 parts by mass of the positive electrode active material obtained in each of Examples 1 to 5 and Comparative Example 1, 10 parts by mass of acetylene black, and 10 parts by mass of polyvinylidene fluoride in N-methylpyrrolidone as a solvent. This slurry was applied onto an aluminum foil, pressed at 15 tons, and punched with a puncher having a diameter of 10 mm to produce a positive electrode. At this time, the mass of the positive electrode active material was adjusted to 3.5 mg.

### (Production of Coin-Type Cell)

The produced positive electrode (diameter of 10 mm) was placed on a positive electrode can, a porous polyethylene film serving as a separator was placed thereon, and pressure was applied with a polypropylene gasket. Thereafter, a Li negative electrode having a thickness of 0.5 mm was placed, and a spacer for thickness adjustment was placed. Thereafter, as a non-aqueous electrolyte solution, a mixed solvent of ethylene carbonate and diethyl carbonate (volume ratio: 5:5) in which 1 mol/L of lithium hexafluorophosphate was dissolved was added between the positive electrode can and the negative electrode and impregnated into the separator, and a negative electrode can was placed thereon and sealed to prepare a coin-type cell (lithium ion secondary battery). [Evaluation of Battery Performance]

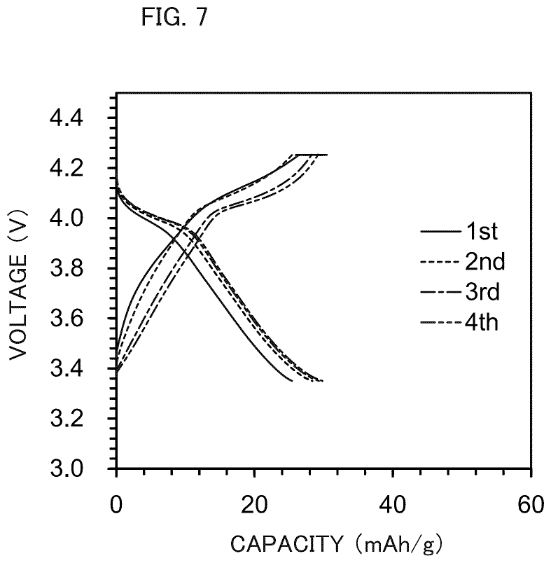

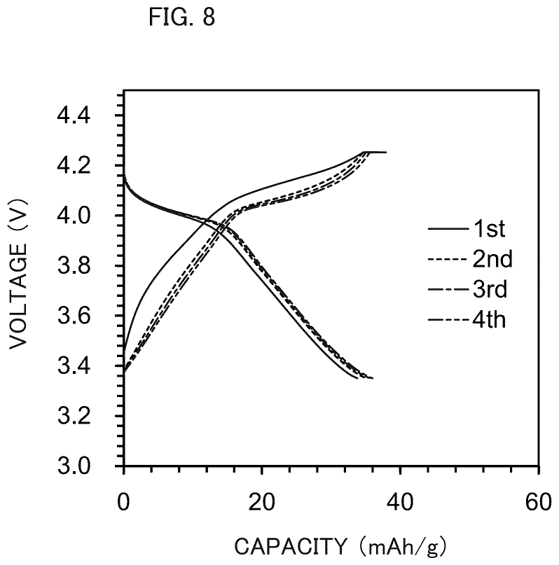

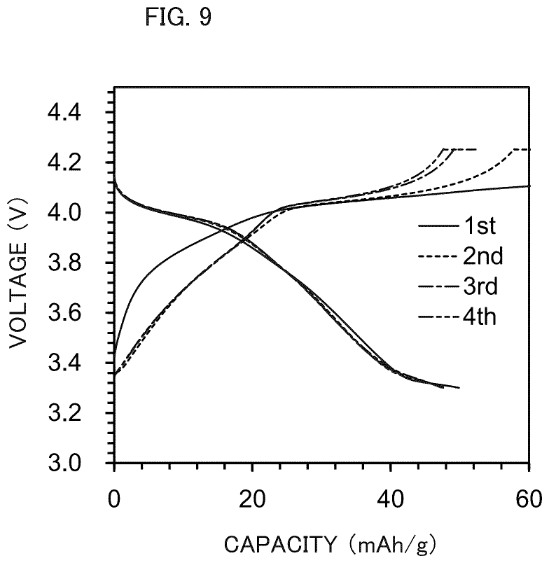

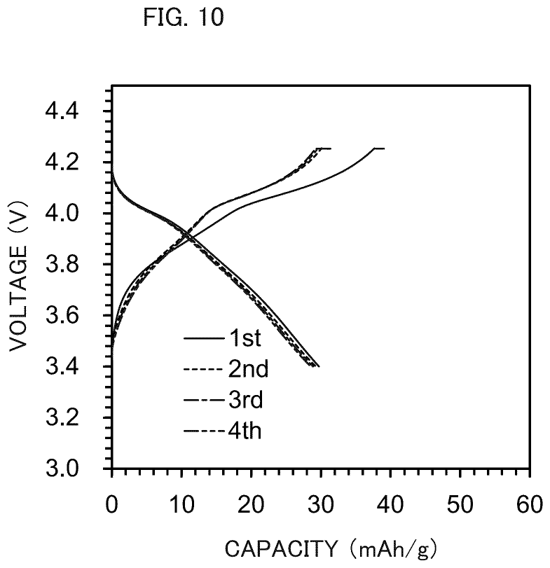

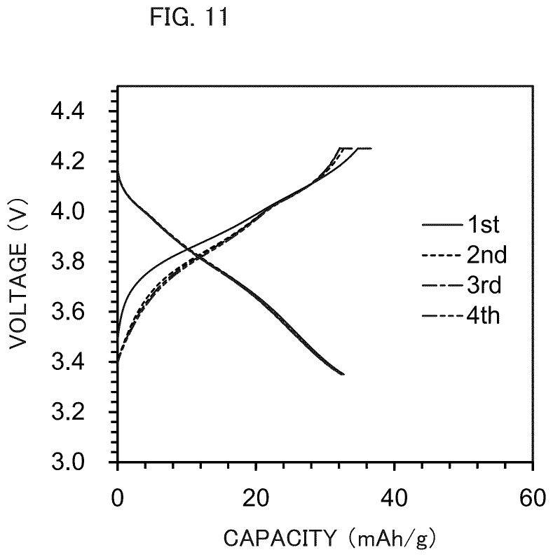

The battery performance was evaluated by using the produced coin-type cell. Specifically, the produced coin-type cell was charged and discharged with a constant current at a current value of 5 mA/g per mass of the positive electrode active material. During charge and discharge with a constant current, the upper limit voltage was set to 4.25 V, and the lower limit voltage was set to 3.35 V. The resting time after charge and discharge was 10 minutes. The charge and discharge capacity (mAh/g) was calculated per unit mass of the positive electrode active material. The charge-discharge curves during charge and discharge at a constant current in each of Examples 1 to 5 and Comparative Example 1 are illustrated in FIGS. 7 to 12.

In Examples 1 to 5 to which the present invention was applied, the energy densities were 113 Wh/kg, 136 Wh/kg, 175 Wh/kg, 108 Wh/kg, and 119 Wh/kg, respectively. As illustrated in FIGS. 7 to 11, in Examples 1 to 5 to which the present invention was applied, the average discharge voltages were 3.76 V, 3.79 V, 3.73 V, 3.79 V, and 3.72 V, respectively. As described above, in Examples 1 to 5 to which the present invention was applied, it was confirmed that the energy densities and the average discharge voltages were high, and high energy density and high voltage operation could be achieved.

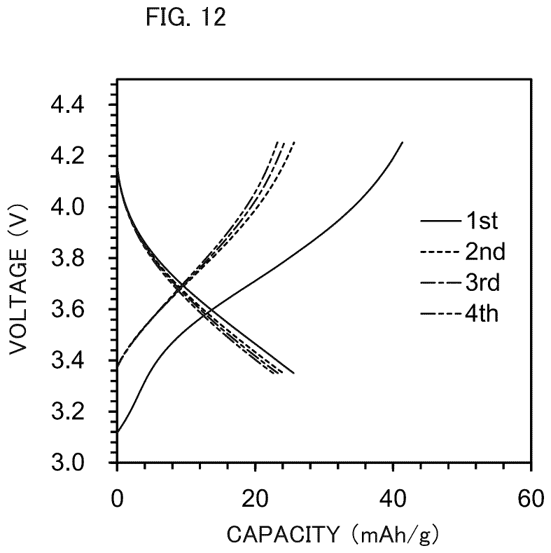

In contrast, in Comparative Example 1 (LiFeF₃) in which the positive electrode active material did not contain the compound represented by Formula (1), the energy density was 87 Wh/kg, and as illustrated in FIG. 12, the average discharge voltage was 3.64 V.

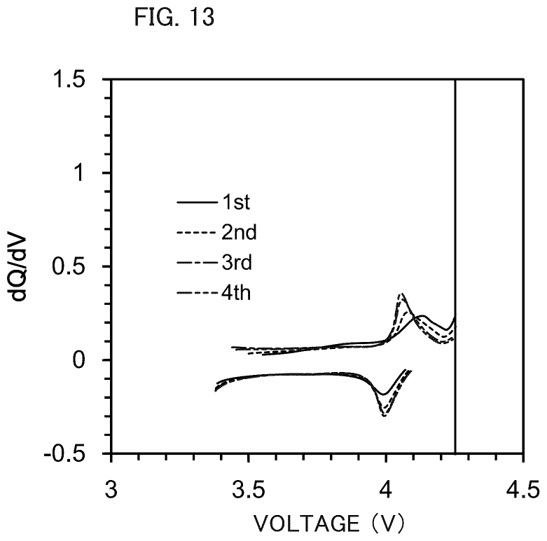

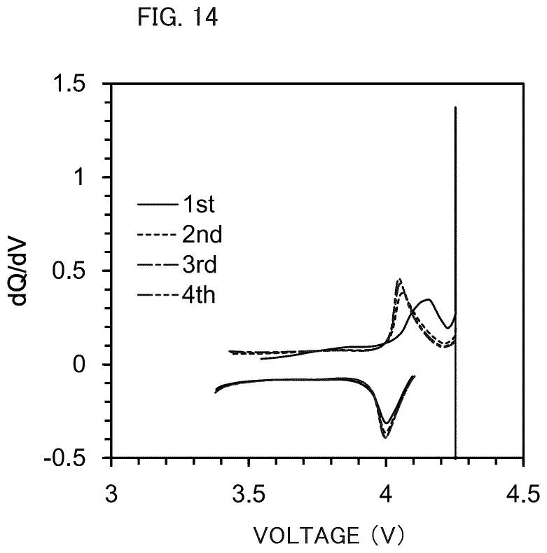

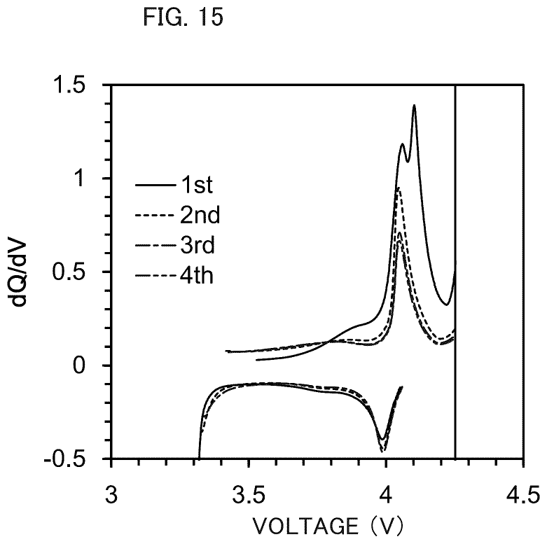

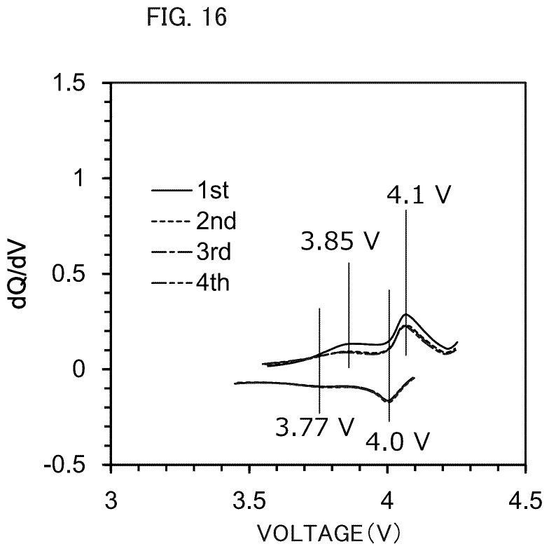

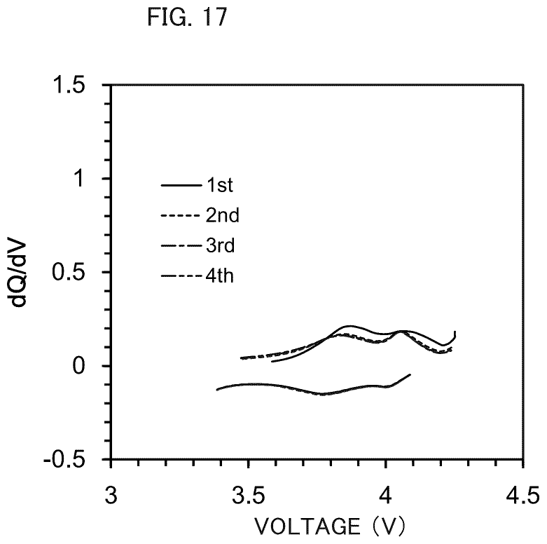

From the obtained charge-discharge curves, dQ/dV plots were created with the horizontal axis representing the voltage and the vertical axis representing the value obtained by differentiating the capacity with respect to the voltage (dQ/dV, dodV⁻¹), and the voltage at which a chemical reaction occurred (reaction voltage) was determined from the peak voltage of each of the dQ/dV plots during discharge. The dQ/dV plots in Examples 1 to 5 and Comparative Example 1 are illustrated in FIGS. 13 to 18.

As shown in FIGS. 13 to 17, in Examples 1 to 5 to which the present invention was applied, the peak voltage of each of the dQ/dV plots during discharge was as high as 3.77 V to 4.0 V, and it was confirmed that the chemical reaction occurred at a high voltage inherent to the compound represented by Formula (1).

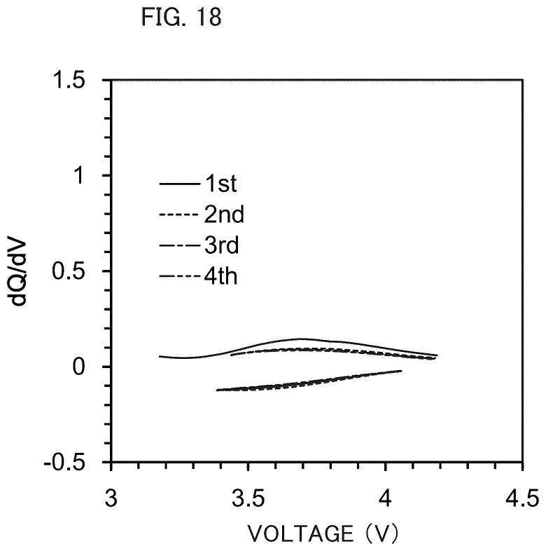

On the other hand, in Comparative Example 1 (LiFeF₃) in which the positive electrode active material did not contain the compound represented by Formula (1), as illustrated in FIG. 18, the peak voltage of the dQ/dV plot during discharge was not observed around 4 V, and only a broad peak was illustrated in the operating voltage range. It is considered that in order to observe a clear reaction of Fe²⁺/Fe³⁺, it is necessary to lower the lower limit of the operating voltage range, and in Comparative Example 1, a chemical reaction occurs at a voltage lower than the lower limit voltage of 3.35 V of the present example.

From the above-described results, according to the present invention, it has been found that it is possible to provide the positive electrode active material that is based on Fe and capable of operating at a high voltage, and the lithium ion secondary battery containing the positive electrode active material.

What is claimed is:

1. A positive electrode active material comprising a lithium-iron composite fluoride as a principal component,
the lithium-iron composite fluoride being represented by Formula (1) below,
LiₓFeF₍₃₊ₓ₎ (1)
where, x is a number satisfying 0.5<x<1.5.

2. The positive electrode active material according to claim 1, wherein, in Formula (1), x satisfies 0.6≤x≤ 1.0.

3. The positive electrode active material according to claim 1, wherein the positive electrode active material has a peak in a range of 20°≤2θ<25° and a range of 25°≤2 θ≤30° in an X-ray diffraction pattern.

4. A lithium ion secondary battery comprising: a positive electrode; a negative electrode; and an electrolyte, wherein the positive electrode contains the positive electrode active material according to claim 1.

5. The lithium ion secondary battery according to claim 4, wherein a dQ/dV plot during discharge in a charge-discharge cycle has a peak in a range of 3.77 to 4.0 V.

6. The lithium ion secondary battery according to claim 4, wherein a peak height at 3.77 to 4.0 V is 1.2 times to 4.4 times a peak height at 3.3 to 3.5 V in a dQ/dV plot during discharge in a charge-discharge cycle.

7. The lithium ion secondary battery according to claim 4, wherein an average discharge voltage is 3.8 to 4.0 V.

8. The lithium ion secondary battery according to claim 4, wherein the electrolyte is a liquid electrolyte, a solid electrolyte, or a semi-solid electrolyte.

9. The lithium ion secondary battery according to claim 4, wherein the negative electrode is formed of metallic lithium or graphite.
